(19) United States
(12) Patent Application Publication
(10) Pub. No.: US 2009/0204544 A1
(43) Pub. Date: Aug. 13, 2009

(54) ACTIVATION BY TRUST DELEGATION

(75) Inventors: Richard S. Eizenhoefer, Redmond, WA (US); Brian Stuart Perlman, Bothell, WA (US); Aaron J. Smith, Everett, WA (US); David Robinson, Seattle, WA (US); Tarik Soulami, Redmond, WA (US); Kalin Raykov Kopachev, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/028,737

(22) Filed: Feb. 8, 2008

(51) Int. Cl. H04L 9/32; G06Q 10/00

(52) U.S. Cl. 705/59; 705/1; 705/7

(57) ABSTRACT

A mechanism for delegating trust to activate a target program from the vendor (or its intermediary) to a customer (or its intermediary) using an issuance license. The customer may then activate using their own authentication implementation. Also, a method for formulating an issuance license that permits such delegation. Furthermore, a method for an entity outside of a customer to gather trace information from the activation process after the fact that allows a customer to identify the activating entity without the outside entity first identifying the activating entity.

### BACKGROUND

Software vendors often license their proprietary computer software programs. The installation of non-licensed copies of such programs is often termed “software piracy”. Product activation is a license validation procedure that is designed to prevent software piracy. Product activation may allow the user to gain or continue full or more complete access to the functionality of the product as permitted by the license.

Product activation often, if not always, involves communication with the software vendor either directly by Internet or telephone, or indirectly via a proxy. The use of an activation proxy occurs most often with volume licenses, in which a vendor grants a larger number of licenses to a customer in bulk, as opposed to a license agreement for each machine.

In a disconnected environment, communication with the software vendor may not be possible. In a high security environment, there may be severe restrictions on the ability to communicate with the software vendor. Accordingly, in these and any other environments in which the ability to communicate with the software vendor is inhibited, it may be quite difficult, if not impossible, to deploy the product.

### BRIEF SUMMARY

At least some embodiments described herein relate to an activation mechanism for activating a target program is described. Activation involves proving that the customer is properly licensed to use the target program. Upon successful activation, features of the target program may then be unlocked, or perhaps the ability to use the program is extended consistent with the license. In conventional activation, the vendor approves or declines an activation request. In contrast, the principles described herein permit an entirely different paradigm for activation. Specifically, the vendor delegates trust to activate a target program to the customer (or at least to a trust authority used by the customer). This delegation is represented in the form of an issuance license that the vendor issues to the customer.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 schematically illustrates an environment in which an issuance license may be evaluated in the process of a customer activating a target computer program;

FIG. 3 illustrates a flowchart of a method for delegating trust for activation of a target computer program to a customer;

FIG. 4 illustrates a schematic of an issuance license data structure that may be used to delegate trust to a customer or their surrogate;

FIG. 5 illustrates a flowchart of a method of an activator computer program to activate a target computer program; and

FIG. 6 illustrates a flowchart of a method for allowing a customer to as confidentially use trace information from an activation to identify an activating entity that initiated the activation.

### DETAILED DESCRIPTION

In accordance with embodiments described herein, an activation mechanism for activating a target program is described. Activation involves proving that the customer is properly licensed to use the target program. Upon successful activation, features of the target program may then be unlocked, or perhaps the ability to use the program is extended consistent with the license. In conventional activation, the vendor approves or declines an activation request. In contrast, the principles described herein permit an entirely different paradigm for activation. Specifically, the vendor delegates trust to activate a target program to the customer (or at least to a trust authority used by the customer). This delegation is represented in the form of an issuance license that the vendor issues to the customer.

The vendor may identify multiple possible authentication mechanisms that the vendor considers trustworthy. The customer might then select an authentication mechanism that is available to the customer, and then identify to the vendor the selected authentication mechanism along with one or more corresponding trust points.

If the identified authentication implementation is acceptable to the vendor for use when activating the target program, the vendor constructs an issuance license, and provides the issuance license to the customer. The issuance license might specify, for example, the target program that is to be activated, and the authentication implementation that is to be used to authenticate any activating entity that drives the activation process, and potentially one or more other criteria to be imposed during the activation (either as proposed by the customer, or as required by the vendor).

The activator program consults the issuance license when activating the target program. In particular, the activator program causes authentication of the activating entity to occur using the authentication implementation specified in the issuance license. If there are one or more additional activation criteria specified in the issuance license, those criteria are also checked. If the authentication is performed using the specified authentication implementation, and the one or more criteria, if any, are met, the activator program allows the activation to occur.

In one embodiment, the activation process causes trace information to be generated and collected by an entity outside of the customer. The trace information is sufficient for the outside entity to identify the customer, but cannot identify the activating entity without being within the context of the customer's authentication implementation. Should the outside entity detect a misuse of the license, the trace information may be provided to the customer. The customer may use the trace information in conjunction with the authentication implementation previously used to activate to identify the entity within their organization that caused the suspect activation to occur. The customer can then take appropriate action to correct the misuse, and/or to correct any security breach that may be implicated in the misuse, without the outside entity being given information regarding the entity that caused the activation.

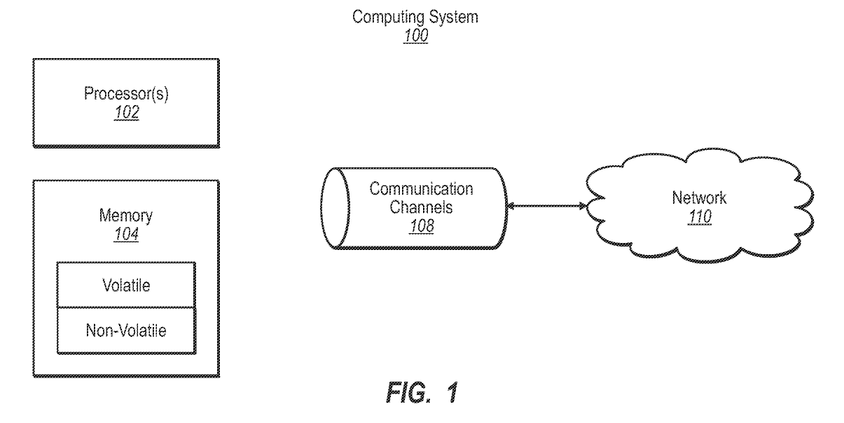

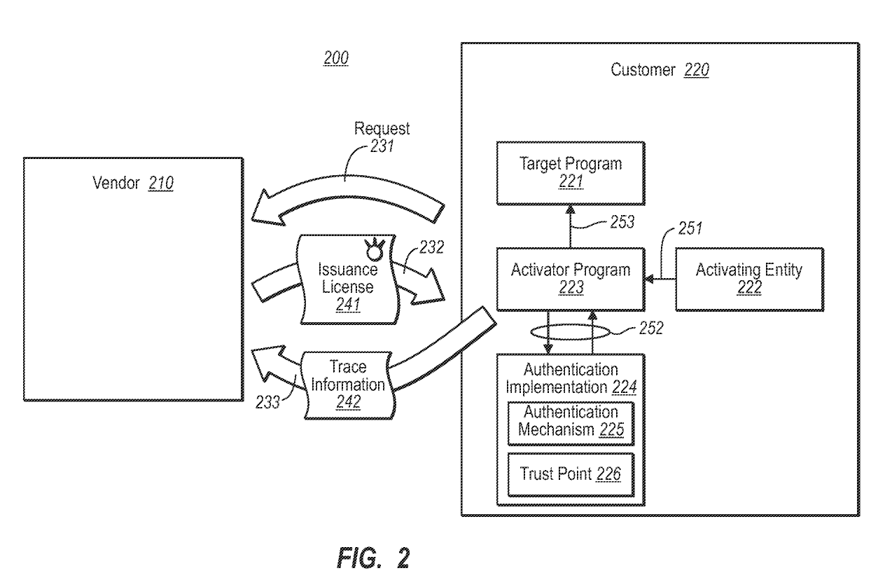

First, some introductory discussion regarding message processors will be described with respect to FIG. 1. Then, various embodiments of a message dispatch engine will be described with respect to FIGS. 2 through 6.

A message processor may be implemented in software or hardware, or a combination thereof. FIG. 1 illustrates a computing system, which may implement a message processor in software. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems. That said, a “message processor” is not even limited to use in a computing system at all.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates an environment 200 in which an issuance license is used to delegate trust from a vendor (or its surrogate) to a customer (or its surrogate). The environment 210 includes a vendor 210 and a customer 220.

The vendor 210 may be a person or an organization, and includes any entity that is authorized to license a target computer program that is to be activated. In one example, the vendor 210 might be the entity that authored the target computer program, although this is not required. The vendor 210 may own the licensing rights to the target computer program. On the other hand, the vendor 210 may simply be an agent of the entity that owns the licensing rights.

The customer 220 may also be a person or an organization, and includes any entity that is to activate the target computer program. The customer 220 might include the end-users that will ultimately be using the target computer program. Alternatively, the customer 220 might be a retailer that sells the target computer program and facilitates activation for the end-user organization or individuals. Accordingly, as the terms are used herein, the terms “vendor” and “customer” should be interpreted broadly.

The customer 220 has access to a target program 221 that is to be activated. In a single-use license agreement, only one copy of the target program 221 is to be activated on a single machine. For instance, perhaps the target program 221 is to be installed on the computing system 100 of FIG. 1. On the other hand, in a volume license agreement, multiple copies of the target program 221 may be activated on multiple machines in accordance with the volume license agreement. The principles described herein may apply regardless of whether the license agreement is single-use or volume, and regardless of the other various terms of the license agreement.

The customer 220 includes an activating entity 222. The activating entity may be, for example, a human being, or may be a computer program or entity (such as an object, component, module, device or the like) associated with the customer 220. The activating entity may also comprise information (such as a user name and password, or a certificate) that would be authenticated as part of the activation process. If many copies of the target computer program 222 are to be activated, there may potentially be many activating entities, and the process of activation may be repeated many times.

The customer 220 also includes an activation computer program 223, which drives the activation process. The activation computer program 223 may be a separate program or may be part of a more comprehensive program that performs other functionality. The activation computer program 223 may actually be part of the target computer program 221 being activated. The activation computer program 223 may be installed and run on a computing system such as that described with respect to FIG. 1.

The customer 220 also includes an authentication implementation 224 that may be used for authenticating the activating entity that requests activation of the target computer program 221. The authentication implementation 224 includes an authentication mechanism 225 and a corresponding trust point 226. The authentication implementation 224 may perhaps be used to authenticate for other purposes as well, although not important to the principles described herein. It is not important to the broader principles described herein the precise authentication implementation 224, authentication mechanism 225 or trust point 226 used by the customer. There may even be multiple types of authentication mechanisms used by the customer, each with perhaps a distinct trust point appropriate for that authentication mechanism. Various types of authentication mechanisms that may be used consistent with the principles described herein will be described. However, those of ordinary skill in the art will recognize, after having read this description, that the principles described herein may be used with any authentication mechanism.

For example, the authentication mechanism may be an enterprise authentication service. Examples of such enterprise authentication services include ACTIVE DIRECTORY®, Kerberos, server-side Simple Authentication and Security Layer (SASL) compliant authentication mechanisms, Public Key Infrastructure (PKI) and so forth. The authentication mechanism may also be or use an Internet identity service. Examples of such include WINDOWS LIVE™ and Security Assertion Markup Language (SAML). The authentication mechanism may also be based on presence of a physical device accessible to the activating entity. For example, the device may be a Hardware Security Module (HSM) or a Trusted Platform Module (TPM).

Since PKI is often an authentication infrastructure widely used by customers, particularly in a volume licensing situation, the process flow described below will sometimes refer to a specific example in which PKI is used as the authentication mechanism at the customer. However, this example (called the “PKI example” further below) is used only for illustrative purposes, and not for limiting the inventive principles to that specific authentication mechanism. There are an unlimited number of authentication mechanisms that may be used consistent with the principles of the present invention. Any authentication mechanism, whether now existing, or whether developed in the future, may be used with the broader principles described herein.

These various components within the customer 220 interoperate, and the customer 220 and the vendor 210 collaborate to facilitate activation of the target computer program 221. In this description and in the claims, the term “activation” and “activate” is to be interpreted broadly. In one embodiment, the target computer program may be essentially nonoperational before activation, while activation causes one, some or all of the features of the target computer program to become functional. Alternatively, perhaps there was some level of functionality available before activation, while activation unlocks one or more further functions of the target computer program. Also, perhaps the target computer program was fully functional prior to activation (e.g., during a trial period, or during a limited term license), but activation extends the period of functionality (perhaps, but not necessarily indefinitely). Alternatively, there may be several levels of activation, each unlocking yet further features of the target computer program and/or extending the use period for certain features.

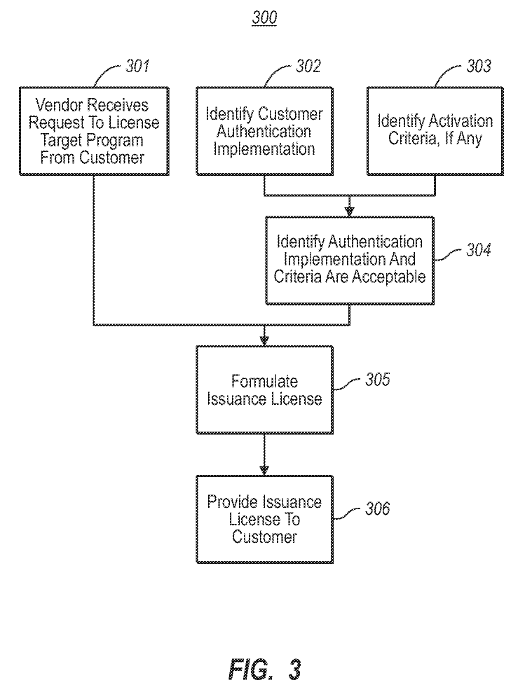

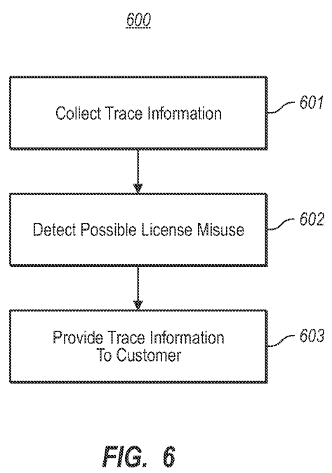

Having described the vendor 210 and customer 220, and the various components thereof, various process flows that may occur within environment 200 of FIG. 2 and which are illustrated in FIG. 2 will now be described with respect to the subsequent figures. In particular, FIG. 3 illustrates a process flow in which the vendor 210 may issue an issuance license that permits the customer to use an authentication implementation available to the customer to activate the target computer program. FIG. 5 illustrates a process flow in which the customer activates the target computer program using the issuance license. FIG. 6 illustrates a process flow in which an outside entity may collect trace information to assist the customer in identifying an activating entity within its organization, while assuring confidentiality of the activating entity outside the context of the authentication mechanism used by the customer.

First, FIG. 3 will be described with respect to FIG. 2. FIG. 3 illustrates a flowchart of a method 300 for delegating trust for activation of a target computer program to the authentication implementation used by the customer of the target computer program. In particular, in FIG. 2, vendor 210 is delegating trust for activating the target computer program 221 to the customer 220 (or more particularly the authentication implementation 224). Note that although the authentication implementation 224 is illustrated as being within the customer 220 in FIG. 2, the authentication implementation 224 may involve interaction with an authentication mechanism 225 that may be outside of the customer organization (as in the case of Internet-based authentication). That said, the authentication mechanism 225 may also be internal to the customer organization as is the case with enterprise-based authentication mechanisms such as ACTIVE DIRECTORY®.

Referring to FIG. 3, the vendor 210 receives a request to license the target computer program to the customer (act 301). This request may come from the customer 220 as represented by the arrow 231 in FIG. 2. However, the request may have also come from some other party. The request may be an electronic request. For instance, the request 231 may be an electronic request to activate made over a computer network such as the Internet. However, the request 231 may also occur in a social environment from a human being, or a collection of human beings interfacing with corresponding representatives of the vendor, and may perhaps be the result of extended negotiations and deliberations. In one embodiment, the vendor may present a choice of acceptable authentication mechanisms. The customer may then evaluate the choices to match against authentication mechanisms that are available to the customer. The customer may then select one or more matching authentication mechanism, and provide corresponding trust points that the customer implements for each of the selected authentication mechanisms.

Referring back to FIG. 3, the vendor also identifies an authentication implementation that is available to the customer (act 302). For instance, in FIG. 2, the customer 220 may select the authentication mechanism 225 and provide the trust point 226 associated with that authentication mechanism 225. This may be included with the request 231 from the customer. However, if the request is made within human discussions, the authentication implementation may be made known during the course of such discussions. In the PKI example, the customer would identify that PKI is the authentication mechanism that is available to the customer, and would identify the trust point associated with the PKI authentication mechanism. For instance, the PKI trust points may include one or more certificate authorities used by the customer (e.g., a root certificate authority, and perhaps one or more intermediate authorities of the PKI infrastructure).

In an electronic request, these certificate authority identifiers may be stored within a token. In this description and in the claims, a “token” is defined as a private cryptographic key that is maintained in protected storage, either through hardware and/or software, that prevents the private key from being revealed or subjected to unauthorized use. Associated with each token is a public key and a public certificate that specifies the identity of the token, authorized uses, and the issuer. Examples of tokens include: SmartCards, TPMs, and PKCS12 files.

In this and other authentication mechanisms and implementations, the vendor would be provided with enough information for the vendor to be able to decide whether that authentication could be trusted for purposes of activation. The identification of the authentication implementation may include an identification of multiple authentication implementations (whether using the same authentication mechanism or different authentication mechanisms) that are available to the customer. The identification of the authentication implementation (act 302) is shown in parallel with the receipt of the request to activate (act 301) because there is no timing relationship required between these two acts. One could occur before, after, and/or concurrent with the other.

The method 300 may optionally also include an act of identifying one or more additional activation criteria (act 303). Such activation criteria may be proposed by the customer 220, or may be imposed by the vendor 210. In one embodiment, one, some or all of the criteria may be proposed as activation conditions in the request to activate. In human negotiations, the criteria may be specified during the negotiations. The act 303 is shown in parallel with acts 301 and 302 in FIG. 3 to emphasize once again that there is no timing relationship required in the time that the activation criteria are identified as compared to the identification of the receiving of the request to activate (act 301) and the identification of the authentication implementation (act 302).

After the vendor identifies the authentication implementation(s) available to the customer, the vender determines whether the authentication implementation(s) are acceptable to use when the customer activates the target program (act 304). In this context, the vendor may decide that the authentication implementation is suitable provided that one or more additional activation criteria are met. If criteria are proposed by the customer, those criteria may be considered. However, even if no criteria are proposed by the customer, the vendor may impose additional criteria. The criteria may depend on the license agreement. For instance, perhaps there are only certain authorized entities within the customer that are authorized to activate the target program. For example, perhaps the customer's IT professionals can activate, but not others; or perhaps employees can activate, but not contractors; or perhaps activation might only occur if done within a certain time period, or within a certain region. The possible criteria are endless, but may depend on the license terms, and upon any terms that the vendor and costumer would like to impose as part of the activation process. This determination (act 304) may be a human decision making process, or may be fully or partially automated by a computer.

Of course, if the authentication implementation and criteria are not acceptable to the vendor, then further interaction between the customer and vendor might be performed if the activation process is to occur. Upon determining that the authentication implementation of the customer (along with potentially other activation criteria) are acceptable for purposes of activating the target program (act 304), the vendor may then formulate an issuance license (act 305). The issuance license may be formulated so as to be in computer-readable form, although not required.

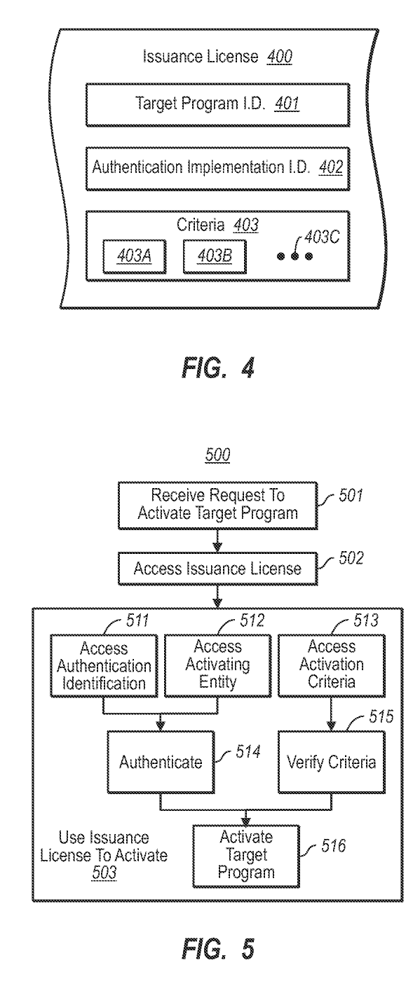

FIG. 4 schematically illustrates a structure of an issuance license 400. If computer-readable, this issuance license 400 may schematically represent a data structure, with each illustrated component representing one or more fields of the data structure. The issuance license 400 is written so that it will be interpreted by the activator computer program to indicate that the customer is delegated the trust to activate the target computer program upon the satisfaction of one or more criteria.

The issuance license 400 includes a target program identifier 401 that identifies the target computer program that is to be activated. The target program identifier 401 may identify the program to be activated by program name and potentially by a version number for that program. In the context of FIG. 2, it is the target computer program 221 that is identified by the target program identifier 401. Alternatively, the program identifier may be interpreted by the overall context of the issuance license 400, or may be otherwise implicit without identifying the target computer program that is to be activated. The issuance license 400 might specify that the activation of multiple programs is being delegated to the customer. In that case, perhaps the issuance license might identify alternative authentication implementations or other criteria to use when activating the other programs.

The issuance license 400 also includes an authentication implementation identifier 402 that represents the authentication implementation that should be used by the customer during the activation process. For instance, in the PKI example, the issuance license may specify that when activating, the customer should use its PKI authentication infrastructure using the root certificate authority and any intermediate authorities that the customer identified to the vendor. For instance, in the PKI example, the issuance license may include the following information: an identifier for the PKI authentication mechanism, a root certificate authority identifier, and optionally one or more intermediate certificate authorities. As a side matter, this information may be signed by the vendor so as to ensure that the issuance license has truly been issued by the vendor, and has not been tampered with.

The issuance license 400 may also optionally include the one or more activation criteria 403. In FIG. 4, these criteria 403 are illustrated as including two criteria 403A and 403B. However, the horizontal ellipses 403C represent that there may be any number of such criteria, even a fewer number than illustrated (perhaps zero or just one such criteria). In one embodiment, these criteria 403 are to be met in order for activation to be successful. However, criteria might also have specified therewith certain levels of optionality, or perhaps alternative criteria that the activator computer program may use to determine whether the criteria are sufficiently met.

After the issuance license is formulated (act 305), the issuance license may be provided to the customer (act 306). For instance, in FIG. 2, arrow 232 shows the issuance license 241 being provided from the vendor 210 to the customer 220. The issuance license 241 may then be made accessible to activator computer program 223 at the customer 220. For instance, if there were but one activator computer program 223 at the customer 223, the issuance license 241 may be stored in a location known to the activator program 223 in the same machine as the activator program.

In a volume license situation, in which there may be a variety of network nodes within the customer 220 at which the target computer program 221 is to be activated, there may an activator program on each of these several nodes of the network. In addition, the issuance license may be stored at each of the several nodes, or at least at a location accessible perhaps over a network.

FIG. 5 illustrates a flowchart of a method 500 for an activator program to activate a target program. For instance, in FIG. 2, activator computer program 223 may activate the target computer program 221. The activation may be initiated upon receiving a request from an activating entity to activate the target computer program (act 501). For instance, referring to FIG. 2, the activating entity 222 requests that the activator computer program 223 activate the target computer program 222. This request is represented by the arrow 251. The activating entity may be a human being, a computing entity (such as a computer program or a device), or data available to the human being (e.g., user name or password), or data available to the computing entity (e.g., a digital certificate). In an ACTIVE DIRECTORY® environment, the activating entity may be a machine account.

The activator computer program then accesses the issuance license previously described (act 502). For instance, the activator computer program 223 may read all or a portion of the issuance license into computer memory, or may perhaps access the issuance license over a network.

The activator computer program then consults the issuance license when activating the target computer program (act 503). There are several acts illustrated as being within act 503 in FIG. 5. Those internal acts represent an example processing flow showing how the activator computer program may use the issuance license to activate the target computer program.

Specifically, the activator computer program identifies the authentication implementation represented in the issuance license (act 511). In the PKI example, the activator program would find that there is PKI authentication mechanism within the issuance license, identify the certificate authorities mentioned in the issuance license, and perhaps verify that the same was signed by a public key of the vendor.

The activator computer program would also access a purported identity of the activating entity. This purported identity may be, for example, in the request 251 to activate received from the activating entity 222.

Also, if there are activation criteria, the activator computer program accesses the one or more activation criteria (act 513) to be used when activating the target program. These activation criteria may include all of the criteria specified in the issuance license, but may also include one or more additional criteria imposed by the customer themselves. For example, in the PKI example, the criteria may be specified as policy Object Identifiers (OIDs). The activation criteria may be related to one or more properties of a public key certificate, but may also specify properties of the environment as well.

The activator computer program then authenticates the purported activating entity using the identified authentication implementation represented in the issuance license (act 514). Referring to FIG. 2, the activator computer program 223 interacts with the authentication mechanism 224 (as represented by arrows 252) to authenticate the activating entity 222. In particular, the authentication implementation 224 uses the authentication mechanism 225 to authenticate the activating entity 222 against the identified trust point 226. Of course, if authentication failed, then the activator computer program 223 denies activation.

Furthermore, if there are activation criteria, the activator computer program verifies that the criteria are sufficiently met (act 515). If they are not sufficiently met, then activation is denied. However, if authentication is successful, and the criteria are met, the activator computer program causes the target computer program to activate (act 516) as represented by arrow 253. Accordingly, the authority to activate a target computer program was delegated to the customer or at least to an authentication implementation available to the customer, instead of being retained by the vendor. Thus, the customer need not be in contact with the vendor to be able to activate once the issuance license is made available to the customer. Furthermore, the vendor was still able to understand and trust the activation process since the vendor was able to enforce conditions on how activation would occur.

FIG. 6 illustrates a flowchart of a method 600 for using trace information generated during the activation to identify circumstances surrounding the misuse of the license. A misuse detection facilitation entity outside of the customer performs the method 600. One example of such an outside entity would be the vendor, but it could also be an agent of the vendor, or even an agent of the customer. Throughout the remainder of this description of FIG. 6, it will be described as being the vendor in order to remain consistent with the example environment of FIG. 2.

The vendor collects trace information generated during activation of the target computer program (act 601). For instance, in FIG. 2, the activator program 223 provides trace information 242 to the vendor 210 as represented by arrow 233. However, the trace information 242 may be generated by other entities as well. For instance, the trace information collection might happen offline, via a printed report, by an external program that analyzes a log file of the activation, during a subsequent customer machine interaction with a vendor or affiliate's web site, or so forth. The trace information may be gathered concurrent with the activation, or may occur long after activation. For example, the trace information may be generated through forensic analysis of the activation well after activation occurred. The trace information may be represented electronically, but may also be represented in any other physical form.

As one specific example, the trace information might include, for example, data that is electronically signed by the activating entity during the activation process. For instance, if a challenge-based authentication occurred as part of the activation process, the trace information could be a signed set of bits resulting from challenge-based authentication. Having said this specific example, however, the trace information is not limited to this example. The trace information may be any information that is sufficient to identify the customer, but not sufficient to identify an activating entity associated with the customer without access to the authentication implementation used by the customer. Even though the vendor may be able to identify the customer's authentication implementation (as they did in the issuance license), the vendor does not have access to use the customer's authentication implementation. Accordingly, the vendor cannot find out information regarding the activating entity using the trace information, and the customer's confidential information is preserved within the customer organization.

Referring again to FIG. 6, the vendor then detects that there is at least the potential that the activation of the target computer program might represent a misuse of the license (act 602). The vendor might not be sure there is a misuse, but suspicion of misuse might have arisen. For instance, if the vendor detects that a number of activations have occurred at a geographical location that is outside the customer organization, a misuse might have occurred. The detection of the potential misuse might have even occurred prior to the gathering of the trace information.

If possible license misuse is detected (act 602), the trace information may be provided back to the customer (act 603). The customer may then use the trace information to identify the activating entity and then take appropriate action. This occurred without the vendor being made aware of who the activating entity is, thereby protecting the confidentiality of the customer while allowing the customer to correct a potential security breach. Alternatively, the trace information may also be collected by the customer without third party involvement.

This has the secondary effect of reducing the potential for license misuse, thereby helping the vendor. However, there are situations where a breach of a license agreement represents a security risk for the customer. Thus, in situations where it is important that the customer maintain high standards of security, an important benefit is that this allows the customer to detect a security breach and take corrective action. For instance, if there are a lot of activations using a customer security device for which only a few activations would be expected, the customer might discover that the activating entity was an individual who had lost their security device. That security device might be used not just to activate computer program, but perhaps to perform other security breaches, such as access sensitive information or locations, or impersonate another.

Thus, the embodiments described herein allow delegation of trust to activate computer programs to the customer, while allowing the vendor to retain confidence in the activation process. Furthermore, the customer can be assisted to detect license misuse and perhaps other security violations that contravene their own internal security policy.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An activator computer program product comprising one of more computer-readable media having thereon computer-executable instructions that, when executed by one or more processors of the computing system, cause the computing system to run an activator computer program that is configured to perform a method for activating an target computer program, the method comprising:
an act of accessing an issuance license that the activator computer program may use to activate the target computer program, and that represents an identification of an authentication implementation that is to be used when activating the target computer program, the authentication implementation including an authentication mechanism and at least one corresponding trust point;
an act of the activator computing system consulting the issuance license when activating the target computer program by performing the following acts:
an act of identifying the authentication implementation represented in the issuance license;
an act of accessing a purported identity of an activating entity, that is requesting activation of the target computer program;
an act of authenticating the purported activating entity using the identified authentication implementation represented in the issuance license; and
at least based in part upon the act of authenticating, an act of causing the target computer program to be activated.

2. The activator computer program product in accordance with claim 1, wherein the authentication mechanism uses an enterprise authentication service.

3. The activator computer program product in accordance with claim 2, wherein the enterprise authentication service uses a Public Key Infrastructure (PKI).

4. The activator computer program product in accordance with claim 1, wherein the authentication mechanism uses an Internet identity service.

5. The activator computer program product in accordance with claim 1, wherein the authentication mechanism is based on presence of a physical device accessible to the activating entity.

6. The activator computer program product in accordance with claim 1, wherein the activating entity is a human being.

7. The activator computer program product in accordance with claim 1, wherein the issuance license further has therein a representation of one or more additional criteria that should be met during activation, the method further comprising:
as an act of determining that the one or more criteria specified in the issuance license have been met, wherein the act of causing the target computer program to be activated is conditioned upon successful completion of the act of authenticating, and the act of determining that the one or more criteria specified in the issuance license have been met.

8. The activator computer program product in accordance with claim 7, wherein at least one of the one or more criteria is related to one or more properties of a public key certificate.

9. The activator computer program product in accordance with claim 7, wherein at least one of the one or more criteria is related to a property of the environment.

10. The activator computer program product in accordance with claim 1, wherein the one or more computer-readable media are physical memory and/or storage media.

11. A method for delegating trust for activation of a target computer program to a customer of the target computer program, the method comprising:
an act of receiving a request to license the target computer program to a customer;
an act of identifying an authentication implementation that is available to the customer, the authentication implementation including an authentication mechanism and at least one corresponding trust point;
an act of determining that the authentication implementation that is available to the customer is an acceptable way to authenticate when activating the target computer program;
an act of formulating an issuance license that will at least implicitly be interpreted by an activator computer program to indicate that the customer is delegated the trust to activate the target computer program upon the satisfaction of one or more criteria, at least one of the one or more criteria specifying that the identified authentication implementation is to be used during activation of the target computer program; and
an act of providing the issuance license to the customer.

12. The method in accordance with claim 11, wherein the request is an electronic request.

13. The method in accordance with claim 11, wherein the act of receiving, identifying, and determining are performed by one or more human beings.

14. The method in accordance with claim 11, wherein the authentication mechanism is a public key infrastructure (PKI), and the trust point includes one or more certificate authorities.

15. The method in accordance with claim 11, wherein the specification of the identified authentication implementation is secured such that the activation computer program can prove the issuance license is authentic, and has not been altered or otherwise tampered with.

16. The method in accordance with claim 11, further comprising:
an act of receiving a request to condition the activation upon at least one of the one or more criteria specified issuance license prior to formulation of the issuance license.

17. A method for allowing a customer who is licensed a computer program governed by a license to detect misuse of the license, the customer having an authentication implementation, the method comprising:
an act of a misuse detection facilitation entity outside of the customer collecting trace information related to an activation of the computer program, wherein the trace information is sufficient to identify the customer, but not sufficient to identify an activating entity associated with the customer without access to the authentication implementation of the customer;
an act of the misuse detection facilitation entity detecting that there is at least potential that the activation related to the trace information may have represented a misuse of the license; and
an act of without the misuse detection facilitation entity itself first identifying the activating entity associated with the activation of the computer program, an act of providing the collected trace information to the customer so that the customer may use the authentication implementation to identify the activating entity.

18. A method in accordance with claim 17, wherein the misuse detection facilitation entity is a vendor of the computer program.

19. A method in accordance with claim 17, wherein the act of detecting is performed by a human being.

20. A method in accordance with claim 17, wherein the trace information includes data that is electronically signed by the activating entity.
